(19) United States
(12) Patent Application Publication
(10) Pub. No.: US 2003/0005269 A1
(43) Pub. Date: Jan. 2, 2003

(54) Multi-precision barrel shifting

(76) Inventors: Joshua M. Conner, Apache Junction, AZ (US); John Elliot, Chandler, AZ (US); Michael I. Catherwood, Pepperell, MA (US); Brian Neil Fall, Chandler, AZ (US); Brian Boles, Mesa, AZ (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/870,458

(22) Filed: Jun. 1, 2001

(51) Int. Cl. G06F 9/00

(52) U.S. Cl. 712/223

(57) ABSTRACT

A processor configuration for processing multi-precision shift instructions is provided. The multi-precision shift instructions are executed following a previous shift instruction of the same increment, such as a logical or arithmetic left or right shift operation. The first shift instruction shifts a first memory word by the shift increment and stores this shifted value into memory. The second, and any subsequent, multi-precision shift instruction shifts the next memory word by the shift increment and concatenates the bits shifted out of the previously shifted memory word into bit positions of the memory word presently being shifted. This concatenated value is then stored back to memory and forms another part of the multi-precision shifted value.

### FIELD OF THE INVENTION

The present invention relates to systems and methods for instruction processing and, more particularly, to systems and methods for providing multi-precision barrel shifting instructions and processing, pursuant to which a value that may comprise multiple words stored in memory may be shifted in a barrel shifter and stored back into multiple memory words.

### BACKGROUND OF THE INVENTION

Processors, including microprocessors, digital signal processors and microcontrollers, operate by running software programs that are embodied in one or more series of instructions stored in a memory. The processors run the software by fetching the instructions from the series of instructions, decoding the instructions and executing them. In addition to program instructions, data is also stored in memory that is accessible by the processor. Generally, the program instructions process data by accessing data in memory, modifying the data and storing the modified data into memory.

One type of instruction that is employed in processors is the shift instruction. Shift instructions conventionally include arithmetic and logical left and right shift instructions and bit rotate instructions. These instructions fetch data from memory, perform the shift on the fetched data and then generally write the result back to memory.

Conventional shift instructions and shift instruction processing work well when data to be shifted is word length data. In this scenario, word length data is fetched from memory, fed into a shifter or barrel shifter on the processor, shifted the requisite amount and then stored back into a memory location. Any bits that are “shifted out” are either lost or may be retrieved using subsequent instructions.

Data stored in memory is not always word length, however, and exceeds the word length of the processor when stored in memory with precision that is an integer multiple of the word length. Such data may be, for example, double precision (32 bit data on a 16 bit processor), triple precision (48 bit data on a 16 bit processor) or higher depending on the application.

When data to be shifted exceeds the word length of the processor, neither conventional shift instructions nor conventional processor hardware are able to handle the shift operation using a single shift instruction per word. This is because multi-precision shifting requires shift and concatenation operations that span successive instruction cycles and memory locations. Conventional processors do not have hardware or instructions to perform these operations directly and in successive processor cycles. Accordingly, if multi-precision shifting operations are to be performed on conventional processors, two, three or more instructions, including shift and non-shift operations such as logical OR's may be required per multi-precision word. These instructions are required to save bits that are shifted out of one memory location and to concatenate the shifted out bits during subsequent shift operations. These conventional software routines and techniques are slow, make inefficient use of processor cycles and can severely handicap performance when processors are engaged in running shift intensive applications.

Accordingly, there is a need for a new method and processor configuration that permits multi-precision shifting and operates with multi-precision shift instructions to provide efficient shifting of multi-precision data. There is a further need for a new shifter that permits shift operations on multi-precision data on successive processor cycles. There is still a further need for shift instructions that permit multi-precision shifts using one shift instruction per multi-precision word.

### SUMMARY OF THE INVENTION

According to the present invention, a method and a processor configuration for processing shift instructions are provided that allow multi-precision shifts using one shift instruction per multi-precision word. The instructions themselves include the following multi-precision shift instructions:

MSL Wb, increment, Wnd (multi-precision shift left by increment)

MSR Wb, increment, Wnd (multi-precision shift right by increment)

Wb and Wnd specify source and destination memory locations from which to retrieve and store data respectively. These instructions are executed following a previous shift instruction of the same increment, such as a logical or arithmetic left or right shift operation. For example, to execute a logical left shift by 4 operation on a data value that spans two memory words, the following simple instruction sequence may be implemented:

SL Wb, 4, Wnd

MSL Wb, 4, Wnd

The first instruction shifts the low order memory word left by four bits and stores this shifted value into memory. The second, multi-precision shift instruction shifts the high order memory word left by four bits and concatenates the four bits shifted out of the low order memory word into the lower bits of the shifted upper word. This concatenated value is then stored back to memory and forms the upper half of the shifted value.

According to one embodiment of the invention, a method of processing a multi-precision shift instruction includes fetching and decoding a multi-precision shift instruction. The method further includes executing the multi-precision shift instruction on an operand within a multi-word value to shift the operand and concatenate the shifted value with bits shifted out of a previous shift operation on the same multi-word value. The result of the shifting is then outputted.

The method may include storing the bits shifted out of the operand during the executing into a carry register. The multi-precision shift instruction itself may be a shift left or a shift right instruction and may specify a shift increment. In addition, the concatenation step is performed by a logical OR operation.

According to another embodiment of the present invention, a processor for processing multi-precision shift instructions includes a program memory, a program counter, and a barrel shifter. The program memory stores program instructions including a multi-precision shift instruction. The program counter identifies current instructions for processing. The barrel shifter executes shift instructions and includes a carry register for storing values shifted out of sections of the barrel shifter and OR logic for concatenating values stored in the carry 0 and carry 1 registers with values in the barrel shifter. The barrel shifter executes a shift instruction fetched from the program memory to a) load an operand into a section within the barrel shifter, b) shift the operand, c) output the shifted value and d) store into the carry register bits shifted out of the section of the barrel shifter.

The barrel shifter may execute a multi-precision shift instruction to further e) concatenate the value in the carry register with the shifted operand prior to outputting the shifted value. The barrel shifter may execute at least two shift instructions to shift a multi-word value. The first instruction of the at least two shift instructions may not be a multi-precision shift instruction, but rather may be an arithmetic or logical left or right shift or other shift operation. However, the second and subsequent instructions of the at least two shift instructions are generally multi-precision shift instructions.

### BRIEF DESCRIPTION OF THE FIGURES

The above described features and advantages of the present invention will be more filly appreciated with reference to the detailed description and appended figures in which:

FIG. 1 depicts a functional block diagram of an embodiment of a processor chip within which embodiments of the present invention may find application.

FIG. 2 depicts a functional block diagram of a data busing scheme for use in a processor, which has a microcontroller and a digital signal processing engine, within which embodiments of the present invention may find application.

FIG. 3 depicts a functional block diagram of a digital signal processor (DSP) engine according to an embodiment of the present invention.

FIG. 4 depicts a functional block diagram of a barrel shifter according to an embodiment of the present invention.

FIGS. 5A and 5B depict a multi-precision barrel shift left by 4 instruction sequence to illustrate multi-precision barrel shift instruction processing according to an embodiment of the present invention.

FIGS. 6A and 6B depict a multi-precision barrel shift right by 4 instruction sequence to illustrate multi-precision barrel shift instruction processing according to an embodiment of the present invention.

FIGS. 7A and 7B depict a multi-precision barrel shift right by 20 instruction sequence to illustrate multi-precision barrel shift instruction processing according to an embodiment of the present invention.

FIGS. 8A and 8B depict a multi-precision barrel shift left by 20 instruction sequence to illustrate multi-precision barrel shift instruction processing according to an embodiment of the present invention.

### DETAILED DESCRIPTION

According to the present invention, a method and a processor configuration for processing multi-precision shift instructions are provided. The multi-precision shift instructions are executed following a previous shift instruction of the same increment, such as a logical or arithmetic left or right shift operation. The first shift instruction shifts the first memory (or register) word by the shift increment and stores this shifted value into memory. The second, and any subsequent, multi-precision shift instruction shifts the next memory word by the shift increment and concatenates the bits shifted out of the previously shifted memory word into bit positions of the memory word presently being shifted. This concatenated value is then stored back to memory and forms another part of the multi-precision shifted value.

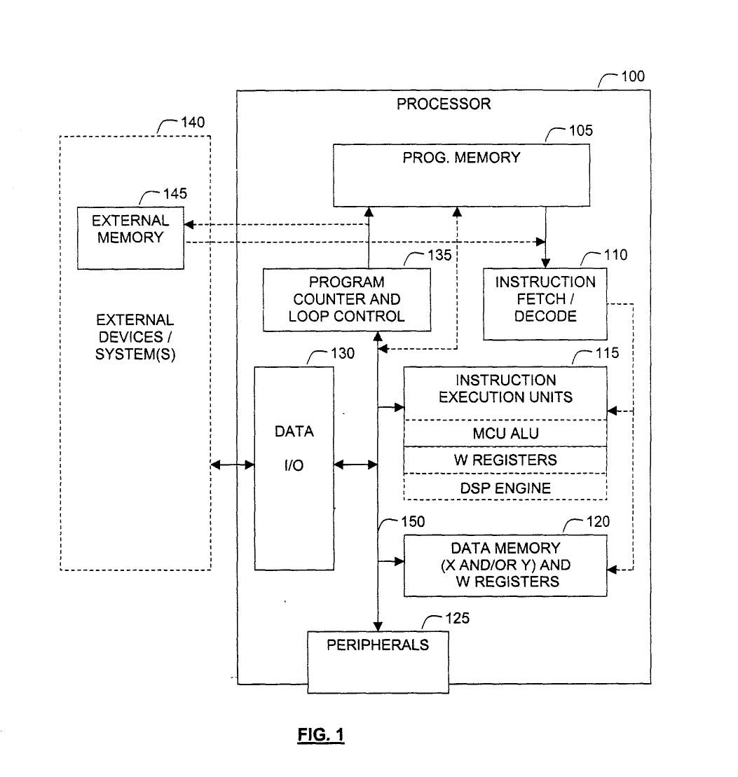

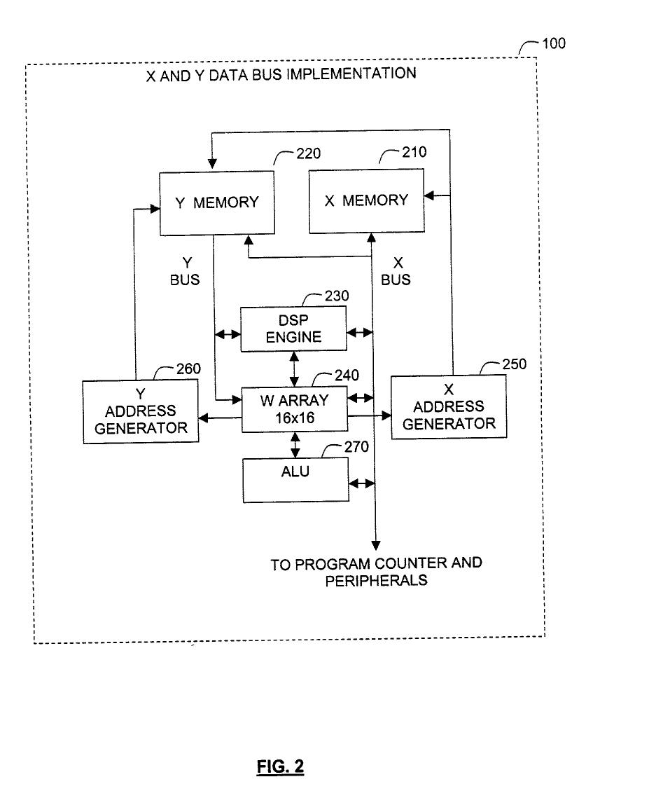

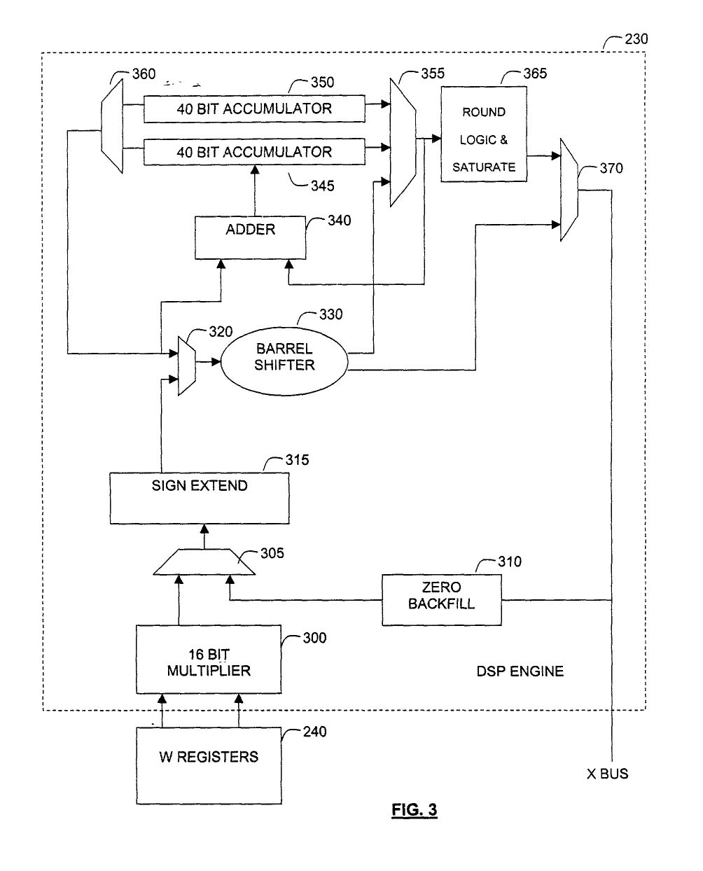

In order to describe embodiments of processing multi-precision shift instructions, an overview of pertinent processor elements is first presented with reference to FIGS. 1 and 2. The systems and methods for implementing multi-precision barrel shifting are then described more particularly with reference to FIGS. 3-8B.

Overview of Processor Elements

FIG. 1 depicts a functional block diagram of an embodiment of a processor chip within which the present invention may find application. Referring to FIG. 1, a processor 100 is coupled to external devices/systems 140. The processor 100 may be any type of processor including, for example, a digital signal processor (DSP), a microprocessor, a microcontroller or combinations thereof. The external devices 140 may be any type of systems or devices including input/output devices such as keyboards, displays, speakers, microphones, memory, or other systems which may or may not include processors. Moreover, the processor 100 and the external devices 140 may together comprise a stand alone system.

The processor 100 includes a program memory 105, an instruction fetch/decode unit 110, instruction execution units 115, data memory and registers 120, peripherals 125, data I/O 130, and a program counter and loop control unit 135. The bus 150, which may include one or more common buses, communicates data between the units as shown.

The program memory 105 stores software embodied in program instructions for execution by the processor 100. The program memory 105 may comprise any type of nonvolatile memory such as a read only memory (ROM), a programmable read only memory (PROM), an electrically programmable or an electrically programmable and erasable read only memory (EPROM or EEPROM) or flash memory. In addition, the program memory 105 may be supplemented with external nonvolatile memory 145 as shown to increase the complexity of software available to the processor 100. Alternatively, the program memory may be volatile memory which receives program instructions from, for example, an external non-volatile memory 145. When the program memory 105 is nonvolatile memory, the program memory may be programmed at the time of manufacturing the processor 100 or prior to or during implementation of the processor 100 within a system. In the latter scenario, the processor 100 may be programmed through a process called in-line serial programming.

The instruction fetch/decode unit 110 is coupled to the program memory 105, the instruction execution units 115 and the data memory 120. Coupled to the program memory 105 and the bus 150 is the program counter and loop control unit 135. The instruction fetch/decode unit 110 fetches the instructions from the program memory 105 specified by the address value contained in the program counter 135. The instruction fetch/decode unit 110 then decodes the fetched instructions and sends the decoded instructions to the appropriate execution unit 115. The instruction fetch/decode unit 110 may also send operand information including addresses of data to the data memory 120 and to functional elements that access the registers.

The program counter and loop control unit 135 includes a program counter register (not shown) which stores an address of the next instruction to be fetched. During normal instruction processing, the program counter register may be incremented to cause sequential instructions to be fetched. Alternatively, the program counter value may be altered by loading a new value into it via the bus 150. The new value may be derived based on decoding and executing a flow control instruction such as, for example, a branch instruction. In addition, the loop control portion of the program counter and loop control unit 135 may be used to provide repeat instruction processing and repeat loop control as further described below.

The instruction execution units 115 receive the decoded instructions from the instruction fetch/decode unit 110 and thereafter execute the decoded instructions. As part of this process, the execution units may retrieve one or two operands via the bus 150 and store the result into a register or memory location within the data memory 120. The execution units may include an arithmetic logic unit (ALU) such as those typically found in a microcontroller. The execution units may also include a digital signal processing engine, a floating point processor, an integer processor or any other convenient execution unit. A preferred embodiment of the execution units and their interaction with the bus 150, which may include one or more buses, is presented in more detail below with reference to FIG. 2.

The data memory and registers 120 are volatile memory and are used to store data used and generated by the execution units. The data memory 120 and program memory 105 are preferably separate memories for storing data and program instructions respectively. This format is a known generally as a Harvard architecture. It is noted, however, that according to the present invention, the architecture may be a Von-Neuman architecture or a modified Harvard architecture which permits the use of some program space for data space. A dotted line is shown, for example, connecting the program memory 105 to the bus 150. This path may include logic for aligning data reads from program space such as, for example, during table reads from program space to data memory 120.

Referring again to FIG. 1, a plurality of peripherals 125 on the processor may be coupled to the bus 125. The peripherals may include, for example, analog to digital converters, timers, bus interfaces and protocols such as, for example, the controller area network (CAN) protocol or the Universal Serial Bus (USB) protocol and other peripherals. The peripherals exchange data over the bus 150 with the other units.

The data I/O unit 130 may include transceivers and other logic for interfacing with the external devices/systems 140. The data I/O unit 130 may further include functionality to permit in circuit serial programming of the Program memory through the data I/O unit 130.

FIG. 2 depicts a functional block diagram of a data busing scheme for use in a processor 100, such as that shown in FIG. 1, which has an integrated microcontroller arithmetic logic unit (ALU) 270 and a digital signal processing (DSP) engine 230. This configuration may be used to integrate DSP functionality to an existing microcontroller core. Referring to FIG. 2, the data memory 120 of FIG. 1 is implemented as two separate memories: an X-memory 210 and a Y-memory 220, each being respectively addressable by an X-address generator 250 and a Y-address generator 260. The X-address generator may also permit addressing the Y-memory space thus making the data space appear like a single contiguous memory space when addressed from the X address generator. The bus 150 may be implemented as two buses, one for each of the X and Y memory, to permit simultaneous fetching of data from the X and Y memories.

The W registers 240 are general purpose address and/or data registers. The DSP engine 230 is coupled to both the X and Y memory buses and to the W registers 240. The DSP engine 230 may simultaneously fetch data from each the X and Y memory, execute instructions which operate on the simultaneously fetched data and write the result to an accumulator (not shown) and write a prior result to X or Y memory or to the W registers 240 within a single processor cycle.

In one embodiment, the ALU 270 may be coupled only to the X memory bus and may only fetch data from the X bus. However, the X and Y memories 210 and 220 may be addressed as a single memory space by the X address generator in order to make the data memory segregation transparent to the ALU 270. The memory locations within the X and Y memories may be addressed by values stored in the W registers 240.

Any processor clocking scheme may be implemented for fetching and executing instructions. A specific example follows, however, to illustrate an embodiment of the present invention. Each instruction cycle is comprised of four Q clock cycles Q1-Q4. The four phase Q cycles provide timing signals to coordinate the decode, read, process data and write data portions of each instruction cycle.

According to one embodiment of the processor 100, the processor 100 concurrently performs two operations—it fetches the next instruction and executes the present instruction. Accordingly, the two processes occur simultaneously. The following sequence of events may comprise, for example, the fetch instruction cycle:

| | |
|---|---|
| Q1: | Fetch Instruction |
| Q2: | Fetch Instruction |
| Q3: | Fetch Instruction |
| Q4: | Latch Instruction into prefetch register, Increment PC |

The following sequence of events may comprise, for example, the execute instruction cycle for a single operand instruction:

| | |
|---|---|
| Q1: | latch instruction into IR, decode and determine addresses of |
| | operand data |
| Q2: | fetch operand |
| Q3: | execute function specified by instruction and calculate destination |
| | address for data |
| Q4: | write result to destination |

The following sequence of events may comprise, for example, the execute instruction cycle for a dual operand instruction using a data pre-fetch mechanism. These instructions pre-fetch the dual operands simultaneously from the X and Y data memories and store them into registers specified in the instruction. They simultaneously allow instruction execution on the operands fetched during the previous cycle.

| | |
|---|---|
| Q1: | latch instruction into IR, decode and determine addresses of |
| | operand data |
| Q2: | pre-fetch operands into specified registers, execute operation in |
| | instruction |
| Q3: | execute operation in instruction, calculate destination address for |
| | data |
| Q4: | complete execution, write result to destination |

DSP Engine and Multi-Precision Barrel Shift Instruction Processing

FIG. 3 depicts a functional block diagram of the DSP engine 230. The DSP engine 230 is coupled to the X and the Y bus and the W registers 240. The DSP engine includes a multiplier 300, a barrel shifter 330, an adder/subtractor 340, two accumulators 345 and 350 and round and saturation logic 365. These elements and others that are discussed below with reference to FIG. 3 cooperate to process DSP instructions including, for example, multiply and accumulate instructions and shift instructions. According to one embodiment of the invention, the DSP engine operates as an asynchronous block with only the accumulators and the barrel shifter result registers being clocked. Other configurations, including pipelined configurations, may be implemented according to the present invention.

The multiplier 300 has inputs coupled to the W registers 240 and an output coupled to the input of a multiplexer 305. The multiplier 300 may also have inputs coupled to the X and Y bus. The multiplier may be any size however, for convenience, a 16×16 bit multiplier is described herein which produces a 32 bit output result. The multiplier may be capable of signed and unsigned operation and can multiplex its output using a scaler to support either fractional or integer results.

The output of the multiplier 300 is coupled to one input of a multiplexer 305. The multiplexer 305 has another input coupled to zero backfill logic 310, which is coupled to the X Bus. The zero backfill logic 310 is included to illustrate that 16 zeros may be concatenated onto the 16 bit data read from the X bus to produce a 32 bit result fed into the multiplexer 305. The 16 zeros are generally concatenated into the least significant bit positions.

The multiplexer 305 includes a control signal controlled by the instruction decoder of the processor which determines which input, either the multiplier output or a value from the X bus is passed forward. For instructions such as multiply and accumulate (MAC), the output of the multiplier is selected. For other instructions such as shift instructions, the value from the X bus (via the zero backfill logic) may be selected. The output of the multiplexer 305 is fed into the sign extend unit 315.

The sign extend unit 315 sign extends the output of the multiplexer from a 32 bit value to a 40 bit value. The sign extend unit 315 is illustrative only and this function may be implemented in a variety of ways. The sign extend unit 315 outputs a 40 bit value to a multiplexer 320.

The multiplexer 320 receives inputs from the sign extend unit 315 and the accumulators 345 and 350. The multiplexer 320 selectively outputs values to the input of a barrel shifter 330 based on control signals derived from the decoded instruction. The accumulators 345 and 350 may be any length. According to the embodiment of the present invention selected for illustration, the accumulators are 40 bits in length. A multiplexer 360 determines which accumulator 345 or 350 is output to the multiplexer 320 and to the input of an adder 340.

The instruction decoder sends control signals to the multiplexers 320 and 360, based on the decoded instruction. The control signals determine which accumulator is selected for either an add operation or a shift operation and whether a value from the multiplier or the X bus is selected for an add operation or a shift operation.

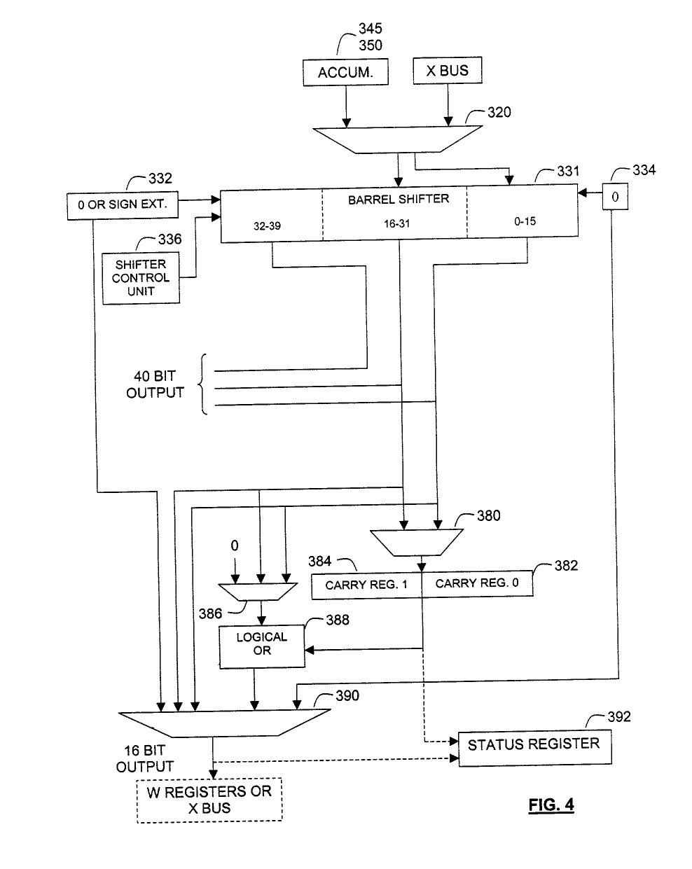

The barrel shifter 330 performs shift operations on values received via the multiplexer 320. The barrel shifter may perform arithmetic and logical left and right shifts and may perform circular shifts in some embodiments where bits rotated out one side of the shifter reenter through the opposite side of the buffer. In the illustrated embodiment, the barrel shifter is 40 bits in length and may perform a 15 bit arithmetic right shift and a 16 bit left shift in a single cycle. The shifter uses a signed binary value to determine both the magnitude and the direction of the shift operation. The signed binary value may come from a decoded instruction, such as shift instruction or a multi-precision shift instruction. According to one embodiment of the invention, a positive signed binary value produces a right shift and a negative signed binary value produces a left shift. A block diagram of the barrel shifter showing additional details is shown in FIG. 4.

The output of the barrel shifter 330 is sent to the multiplexer 355 and the multiplexer 370. The multiplexer 355 also receives inputs from the accumulators 345 and 350. The multiplexer 355 operates under control of the instruction decoder to selectively apply the value from one of the accumulators or the barrel shifter to the adder/subtractor 340 and the round and saturate logic 365.

The adder/subtractor 340 may select either accumulator 345 or 350 as a source and/or a destination. In the illustrated embodiment, the adder/subtractor 340 has 40 bits. The adder receives an accumulator input and an input from another source such as the barrel shifter 331, the X bus or the multiplier. The value from the barrel shifter 331 may come from the multiplier or the X bus and may be scaled in the barrel shifter prior to its arrival at the other input of the adder/subtractor 340. The adder/subtractor 340 adds to or subtracts a value from the accumulator and stores the result back into one of the accumulators. In this manner values in the accumulators represent the accumulation of results from a series of arithmetic operations.

The round and saturate logic 365 is used to round 40 bit values from the accumulator or the barrel shifter down to 16 bit values that may be transmitted over the X bus for storage into a W register or data memory. The round and saturate logic has an output coupled to a multiplexer 370. The multiplier 370 may be used to select either the output of the round and saturate logic 365 or the output from a selected 16 bits of the barrel shifter 330 for output to the X bus.

FIG. 4 depicts a block diagram of the barrel shifter. Referring to FIG. 4, barrel shifter 330 includes a barrel shifter 331 itself. The shifter is shown to receive data via the multiplexer 320 from either accumulator 345 or 350 or from the X bus as described above. The barrel shifter 331 also receives inputs from zero or sign extend logic, zero backfill logic and a shifter control unit 336.

On logical right shift instructions, the zero or sign extend logic 332 causes zeroes to be stored into locations on the left side of the barrel shifter that are vacated as a result of right shifting. On arithmetic right shift instructions, the zero or sign extend logic causes the value of the sign bit (which may be zero or one) to be stored into locations on the left side of the barrel shifter that are vacated as a result of right shifting.

On logical left shift instructions, the zero backfill logic 334 causes zeros to be stored into locations on the right side of the barrel shifter that are vacated as a result of left shifting.

The shifter control unit 336 receives signed binary values taken from the decoded instruction and, in response, causes the value loaded into the barrel shifter to be shifted the specified amount in the specified direction.

The barrel shifter 331 itself is shown divided into three sections. For a 40 bit barrel shifter and a processor with a 16 bit word width, the rightmost section and the central section may each be 16 bits and the leftmost section may be eight bits wide. In the illustrated embodiment, the leftmost bit stores the sign of the value in the barrel shifter. The barrel shifter may output all 40 bits from among the three sections to, for example, the accumulators as described above. Alternatively, the barrel shifter 330 may output 16 bits from the center and rightmost sections to registers that facilitate multi-precision barrel shift operations as well as to the 16 bit X bus.

The rightmost 32 bits of the barrel shifter may be coupled to a multiplexer 380 which has outputs coupled to both a carry 0 register 382 and a carry 1 register 384 which are each 16 bits wide. The carry 1 and carry 0 registers have outputs coupled to a logical OR block 388.

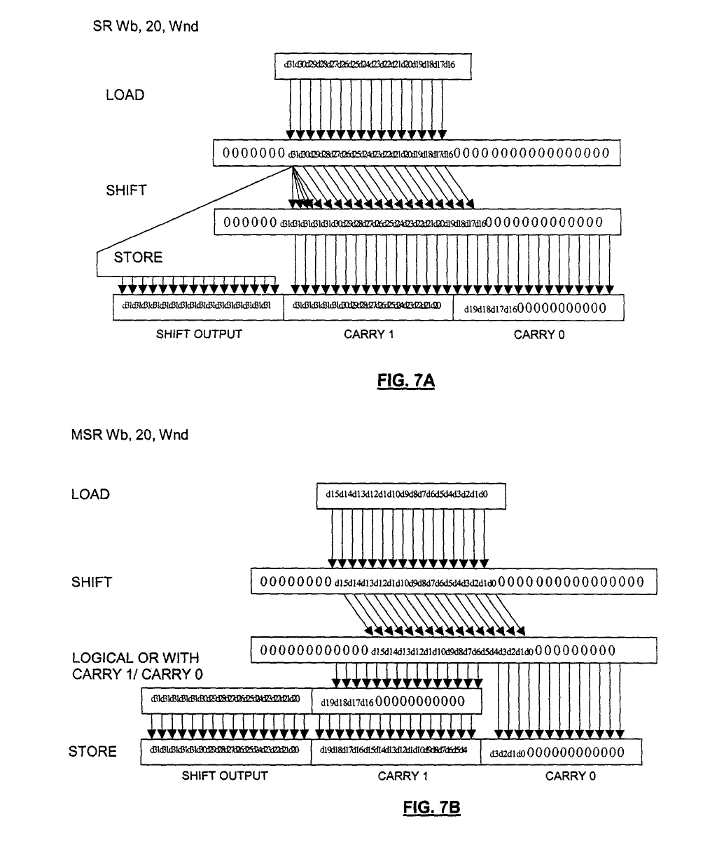

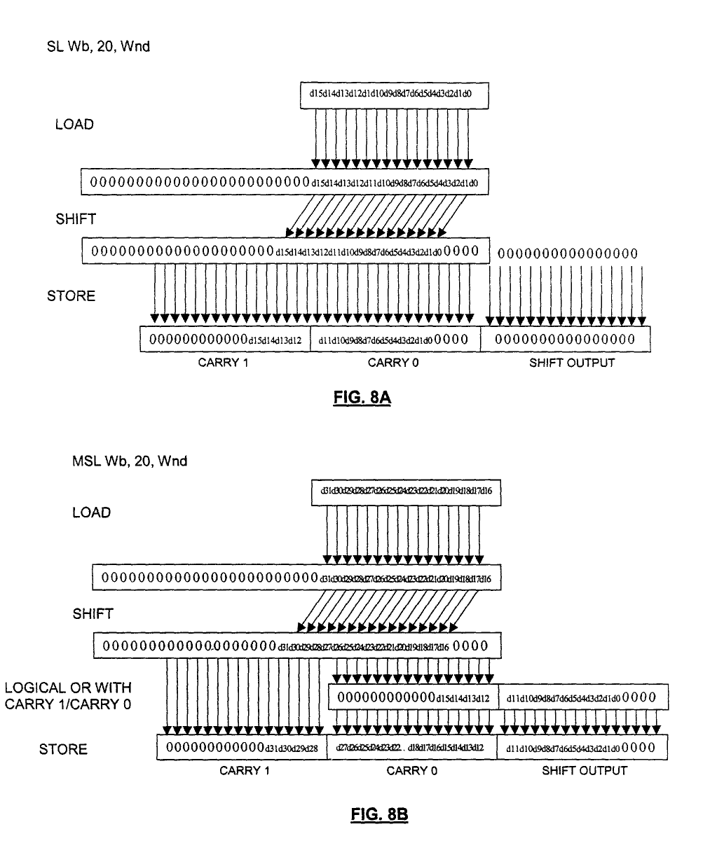

The logical OR block 388 receives inputs from the carry 0 and carry 1 registers and from a multiplexer 386. The multiplexer 386 selectively applies either the rightmost or central section of the barrel shifter or zero to the input of the logical OR based on the decoded instruction. The logical OR block 388 takes the logical OR of the two 16 bit values at its inputs and applies the result to an input of a multiplexer 390. The multiplexer 390 is controlled by the instruction decoded to output 16 bits at a time from the rightmost or central section of the barrel shifter 330 or the 16 bits from the logical OR. When shift instructions with more than 15 bits are encountered, the multiplexer may select 16 bits of zeros or sign extend to output as shown in FIGS. 7A and 8A.

The operation of the carry 0 and carry 1 registers comes into play when multi-precision barrel shift instructions are decoded and executed. The operation of these registers and the OR logic to process a multi-precision barrel shift instruction is explained more fully with reference to the specific multi-precision instruction flow diagrams that follow.

A status register 392 on the processor reflects may certain results of shifting as part of multi-precision shift operations. For example, if a one is written into either of the carry 0 or carry 1 registers as a result of a multi-precision shift operation, a carry flag within the status register 392 may be set to indicate a carry. Other techniques for setting a carry flag may also be implemented. A zero flag within the status register 392 may be set to indicate the presence of a zero value as the operation result when a zero is written out to the memory (or register) location specified by Wnd as a result of a multi-precision shift operation.

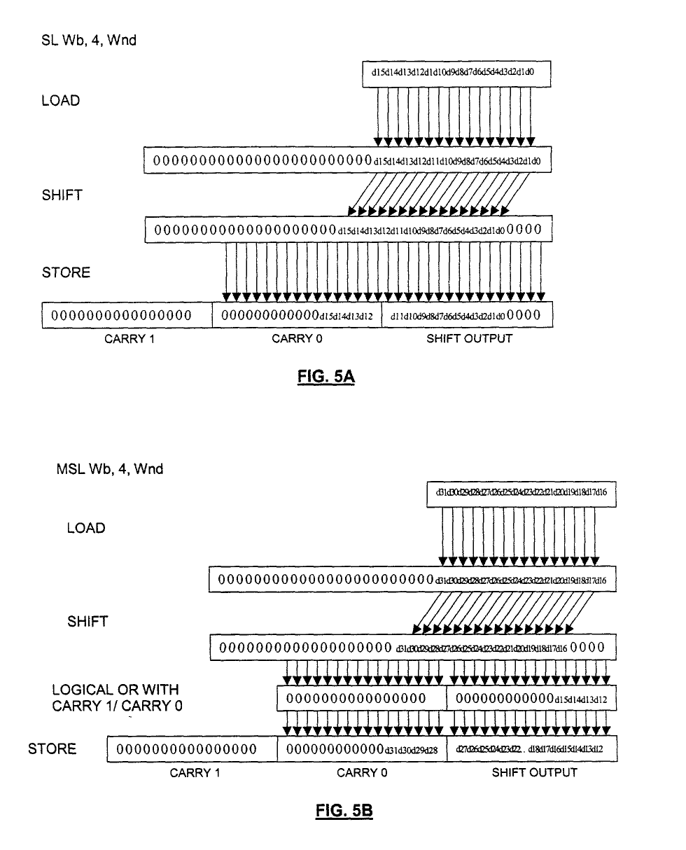

FIGS. 5A and 5B depict a multi-precision barrel shift instruction sequence to illustrate multi-precision barrel shift instruction processing according to an embodiment of the present invention. Referring to FIG. 5A, a shift left instruction is considered:

SL Wb, 4, Wnd—shift left by 4 the contents of WB and store into Wnd

The Wb and Wnd are either registers or pointers to memory. Wb stores a value that is to be shifted and Wnd stores the shifted result after the operation.

During execution of the instruction, the value from Wb is loaded into the barrel shifter 330 and a negative 4 is applied to the shifter control unit 336. The shifter control unit 336 causes the barrel shifter 331 to shift the value to the left by four as shown in FIG. 5A. The lower 16 bits of the shifted value are then taken from the rightmost section of the barrel shifter and stored back into the register or memory location specified by Wnd through proper configuration of the multiplexer 390.

The multiplexer 380 is configured to store the value from the center section of the barrel shifter 330 into the carry 0 register as shown in FIG. 5A. As a result, the carry 0 register stores a 16 bit value, the lower four bits of which are the left most four bits from the Wb register that were left shifted out.

After a SL instruction, one or more MSL instructions may be executed. The MSL is a multi-precision shift instruction. The multi-precision shift instruction allows one to shift values in memory or registers that span more than the word size of the processor. Accordingly, if thirty two bit or forty eight bit values were stored among two or three memory words respectively, the multi-precision instruction may be used to shift the value among three or four memory words respectively within the memory or registers.

Consider the following multi-precision instruction shown in FIG. 5B which is executed after the SL instruction to shift a two word value in memory:

MSL Wb, 4, Wnd—multi-prec. Shift left by 4 the Wb value and store in Wnd.

During execution of the MSL instruction, the value from Wb is loaded into the barrel shifter in the same manner as the SL instruction. Then the barrel shifter contents are shifted left by 4 in the same manner described above. The MSL instruction causes the multiplexer 390 to select the output of the logical OR for outputting to the Wnd register.

The logical OR 388 takes the logical OR of the carry 0 register and the right-most 16 bits. This value is then output to Wnd and includes as its lowest four bits the upper four bits left shifted into the carry 0 register in the SL instruction. The value output also includes as its upper twelve bits the twelve bits that remain in the lower 16 bits of the barrel shifter after the MSL shift by four. In this manner, shifting may be performed on multiple word or multi-precision data with the values shifted out of one word being captured in the proper location in the adjoining word.

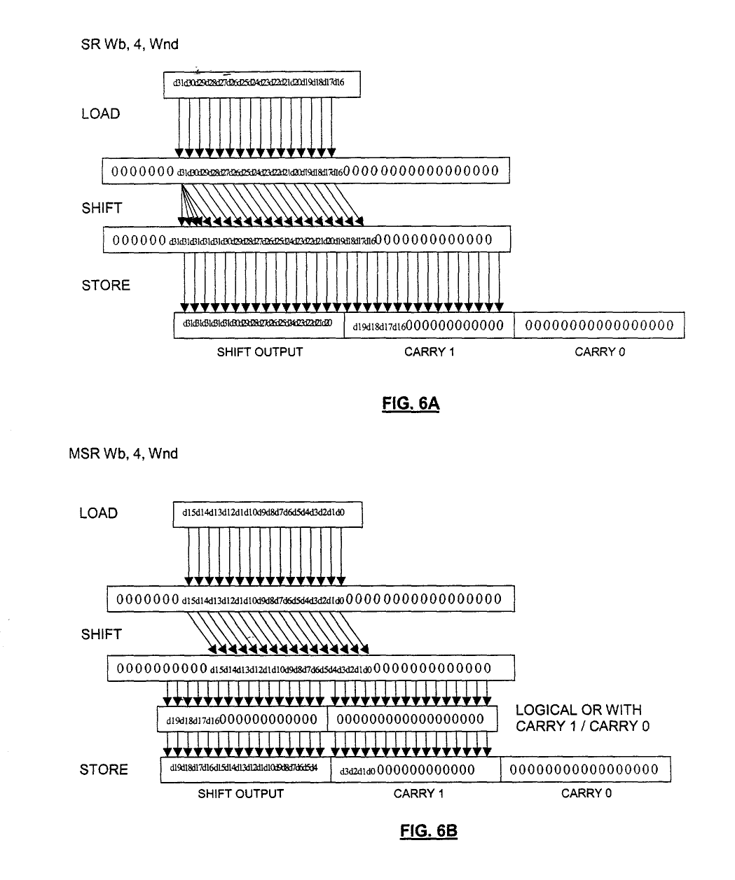

FIGS. 6A and 6B depict a multi-precision arithmetic shift right instruction sequence. Referring to FIG. 6A, the instruction ASR Wb, 4, Wnd causes the value in Wb to be loaded into the center section of the barrel shifter 331 and shifted right by four. The sign extend logic causes the value in the left most bit of the Wb register to be to be copied into the four bit locations vacated by the shift. The sign extended, shifted value from the central section is then selected by the multiplexer 390 and output to the Wnd location. At the same time, the value in the rightmost section of the barrel shifter is stored into the carry 1 register because this is a shift right instruction.

FIG. 6B depicts the following MSR instruction (a multi-precision shift right instruction) executed after the ASR instruction: MSR, Wb, 4, Wnd. Referring to FIG. 6B, the value from Wb is loaded into the center section of the barrel shifter 330 and shifted right by four with a zero extend. The zero extend is done because the sign bit is not part of the value in the Wb register for the MSR instruction.

This causes the shifted value from the center section of the circular buffer to be logically ORed with the carry 1 register. This value, which represents the shifted Wb value and the upper four bits that were right shifted out during ASR instruction processing, is then output to the Wnd register. The lower 16 bits of the barrel shifter are also stored into the carry 1 register, which may be used to correctly execute additional MSR instructions for values that span more than two words.

FIGS. 7A and 7B depict a multi-precision arithmetic shift right instruction sequence where the shift is by 20, which exceeds the word width (16 bit) of the machine. Referring to FIG. 7A, the instruction ASR Wb, 20, Wnd causes the value in Wb to be loaded into the center section of the barrel shifter and shifted right by four (this is twenty minus the word width of the machine 16) as shown in FIG. 7A. The shift by four calculation is made by the shifter control unit 336. The sign extend logic causes the value in the left most bit of the Wb register to be copied into the four bit locations vacated by the shift. Because the right shift is by more than one word, the shifter control unit 336 or the instruction decoder causes the multiplexer 390 to select 16 bits of sign extended data for output to the Wnd register. The sign extended, shifted value from the central section of the barrel shifter is then stored into the carry 1 register and the shifted value from the rightmost section of the barrel shifter is stored into the carry 0 register.

FIG. 7B depicts the following MSR instruction (a multi-precision shift right instruction) executed after the ASR instruction: MSR, Wb, 20, Wnd. Referring to FIG. 7B, the value from WB is loaded into the center section of the barrel shifter 330 and shifted right by four (this is value twenty minus the word width of the machine 16) as with a zero extend. The zero extend is done because the sign bit is not part of the value in the Wb register for the MSR instruction.

The value in the carry 1 register is selected by the multiplexer 390 and output to the Wnd register. The value in the carry 0 register is logically ORed with the value in the central section of the barrel shifter 330 and stored in the carry 1 register. The value in the rightmost section of the barrel shifter is then stored in the carry 0 section. A subsequent MSR Wb, 20, Wnd instructions may be executed to store the remaining bits into a destination register or when the multi-precision value exceeds three word widths.

FIGS. 8A and 8B depict a multi-precision arithmetic shift left instruction sequence where the shift is by 20, which exceeds the word width (16 bit) of the machine. Referring to FIG. 8A, the instruction SL Wb, 20, Wnd causes the value in Wb to be loaded into the rightmost section of the barrel shifter and shifted left by four (this is value twenty minus the word width of the machine 16) as shown in FIG. 8A. The shift by four calculation is made by the shifter control unit 336. The zero backfill logic causes zeros to populate the four bit locations vacated by the shift left.

Because the left shift is by more than one word, the shifter control unit 336 or the decoded instruction causes the multiplexer 390 to select 16 bits of zeros from the zero backfill for output to the Wnd register. The shifted value from the rightmost section of the barrel shifter is then stored into the carry 0 register and the shifted value from the central section of the barrel shifter is stored into the carry 1 register.

FIG. 7B depicts the following MSL instruction (a multi-precision shift left instruction) executed after the SL instruction: MSL, Wb, 20, Wnd. Referring to FIG. 7B, the value from Wb is loaded into the rightmost section of the barrel shifter 330 and shifted left by four (this is value twenty minus the word width of the machine 16) with a zero backfill.

The value in the carry 0 register is selected by the multiplexer 390 and output to the Wnd register. The value in the carry 1 register is logically ORed with the value in the rightmost section of the barrel shifter 330 and stored in the carry 0 register. The value in the central section of the barrel shifter is then stored in the carry 1 section. A subsequent MSL Wb, 20, Wnd instruction may be executed to store the remaining bits into a destination register or when the multi-precision value exceeds three word widths.

In general with the above multi-precision instructions, for a multi-precision shift right instruction in its various forms, the first value for Wb should be the leftmost word of data to be shifted. For a multi-precision shift left instruction in its various forms, the first value for Wb should be the rightmost word of data to be shifted.

While particular embodiments of the present invention have been illustrated and described, it will be understood by those having ordinary skill in the art that changes may be made to those embodiments without departing from the spirit and scope of the invention.

What is claimed is:

1. A method of processing a multi-precision shift instruction, comprising:
fetching and decoding a multi-precision shift instruction;
executing the multi-precision shift instruction on an operand within a multi-word value to shift the operand and concatenate the shifted value with bits shifted out of a previous shift operation on the same multi-word value; and
outputting the result.

2. The method according to claim 1, further comprising storing the bits shifted out of the operand during the executing into a carry register.

3. The method according to claim 1, wherein the multi-precision shift instruction is a shift left instruction.

4. The method according to claim 1, wherein the multi-precision shift instruction is a shift right instruction.

5. The method according to claim 1, wherein the concatenation step is performed by a logical OR operation.

6. The method according to claim 1, wherein the multi-precision shift instruction specifies a shift increment.

7. The method according to claim 6, wherein the shift increment is greater than or equal to the number of bits in a word.

8. The method according to claim 6, wherein the shift increment is less than the number of bits in a word.

9. A processor for processing multi-precision shift instructions, comprising:
a program memory for storing instructions including a multi-precision shift instruction;
a program counter for identifying current instructions for processing; and
a barrel shifter for executing shift instructions, the barrel shifter including:
a carry register for storing values shifted out of sections of the barrel shifter; and
OR logic for concatenating values stored in the carry 0 and carry 1 registers with values in the barrel shifter,
the barrel shifter executing a shift instruction fetched from the program memory to a) load an operand into a section within the barrel shifter, b) shift the operand, c) output the shifted value and d) store into the carry register bits shifted out of the section of the barrel shifter.

10. The processor according to claim 9, wherein the barrel shifter executes a multi-precision shift instruction to further e) concatenate the value in the carry register with the shifted operand prior to outputting the shifted value.

11. The processor according to claim 9, wherein the shift instruction is a shift left instruction.

12. The processor according to claim 9, wherein the shift instruction is a shift right instruction.

13. The processor according to claim 9, wherein the shift instruction is an arithmetic shift instruction.

14. The processor according to claim 9, wherein the shift instruction is a logical shift instruction.

15. The processor according to claim 9, wherein the shift instruction specifies a shift increment.

16. The processor according to claim 9, wherein the barrel shifter executes at least two shift instructions to shift a multi-word value.

17. The processor according 16, wherein the first instruction of the at least two shift instructions is not a multi-precision shift instruction.

18. The processor according 16, wherein the second and subsequent instructions of the at least two shift instructions is a multi-precision shift instruction.
